(19) United States
(12) Patent Application Publication
(10) Pub. No.: US 2025/0243837 A1
(43) Pub. Date: Jul. 31, 2025

(54) TURBINE WITH SHEET-FLOW NOZZLE HAVING ADJUSTABLE WIDTH

(71) Applicant: BHE Turbomachinery, LLC, Portland, OR (US)

(72) Inventors: Henry K. Obermeyer, Wellington, CO (US); David Braun, Loveland, CO (US)

(21) Appl. No.: 19/039,622

(22) Filed: Jan. 28, 2025

Related U.S. Application Data
(60) Provisional application No. 63/626,994, filed on Jan. 30, 2024.

(51) Int. Cl. F03B 15/06; F03B 1/00

(52) U.S. Cl. CPC F03B 15/06; F03B 1/00

(57) ABSTRACT

A turbine that includes a runner and a variable nozzle. The runner is configured to rotate about an axis of rotation. The variable nozzle is configured to produce a sheet flow when fluid passes through the variable nozzle toward the runner. The sheet flow has a circumferential length at an exit of the variable nozzle that is greater than a flow width at the exit of the variable nozzle. The flow width is adjustable. In other configurations, the sheet flow may be planar, conical, or cylindrical.

### CROSS-REFERENCES TO RELATED APPLICATIONS

This patent application claims the benefit of provisional Application No. 63/626,994 filed Jan. 30, 2024. That application is incorporated into the present disclosure by this reference.

### TECHNICAL FIELD

The subject matter is related to an apparatus and methods for improving the performance of a hydraulic impulse turbine.

### BACKGROUND

Hydraulic impulse turbines, such as Pelton turbines and Turgo turbines, are able to utilize high heads, and their power output is able to be varied over a wide range. But existing designs of such turbines have several shortcomings. Their specific speed is very low, resulting in unnecessarily large and unnecessarily expensive generators. Additionally, the blades are prone to fatigue failure because they are subjected to as many as six full-load cycles, depending on the number of nozzles, per revolution.

Francis turbines partially address those disadvantages but come with their own limitations. For example, a Francis turbine retrofitted to a long existing penstock at an existing, previously non-powered dam generates a pressure surge (water hammer) upon load rejection. Also, the power output of Francis turbines cannot be varied over a wide range.

Configurations of the disclosed technology address shortcomings in the prior art.

### BRIEF DESCRIPTION OF THE DRAWINGS

FIG. 1 is a sectional view of a turbine configured to produce a conical-sheet flow and having fixed guide-vanes, according to an example configuration.

FIG. 2 is an isometric, partial sectional view of the turbine of FIG. 1.

FIG. 3 is a sectional view of a turbine configured to produce a conical-sheet flow and having adjustable wicket gates, according to an example configuration.

FIG. 4 is an isometric, partial sectional view of the turbine of FIG. 3, also including an additional detail view of a portion of the turbine of FIG. 3.

FIG. 5 is an axial, end view of the conical-sheet flow exiting the nozzle of the turbine of FIG. 1 or FIG. 3, in an example configuration where the variable nozzle substantially surrounds the axis of rotation.

FIG. 6 is an axial, end view of the conical-sheet flow exiting the nozzle of the turbine of FIG. 1 or FIG. 3, in an example configuration where the variable nozzle partially surrounds the axis of rotation.

FIG. 7 is a diagram illustrating the components of an example conical-sheet flow.

FIG. 8 is an isometric view of a turbine configured to produce a planar-sheet flow, according to an example configuration.

FIG. 9 is a sectional view of the turbine of FIG. 7.

FIG. 10 is a detail view of a portion of the turbine of FIG. 8.

FIG. 11 is a diagram illustrating the components of an example planar-sheet flow.

### DETAILED DESCRIPTION

As described in this document, aspects are directed to apparatuses for improving the performance of a hydraulic impulse turbine by providing a sheet flow to cause the runner to spin as opposed to using one or more circular jets as in previous technologies. Additionally, the width of the sheet can be adjusted. In this way, configurations of the disclosed technology combine the higher specific speed of the Francis turbine with the absence of water hammer during load rejection of impulse turbines, such as Pelton turbines and Turgo turbines, while providing an intermediate range of power modulation.

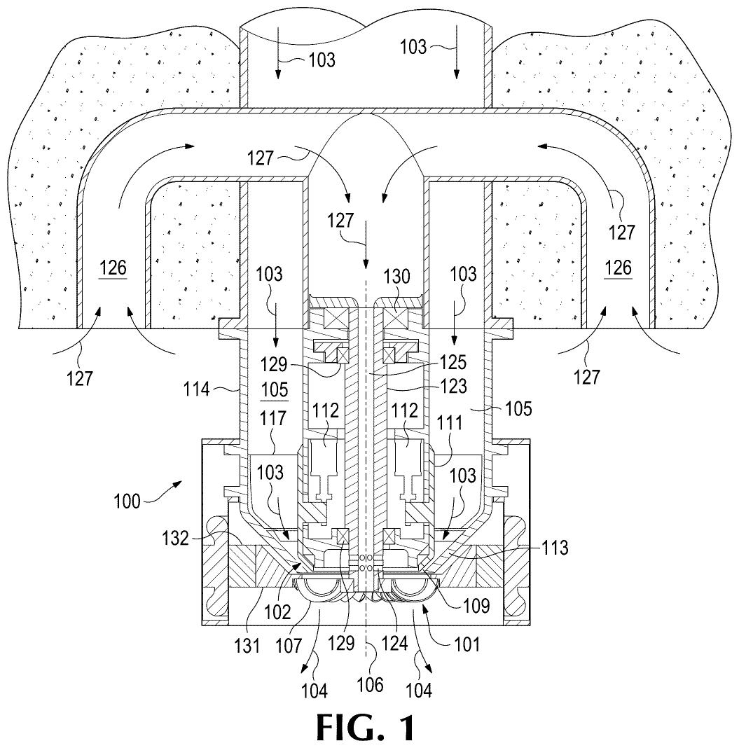

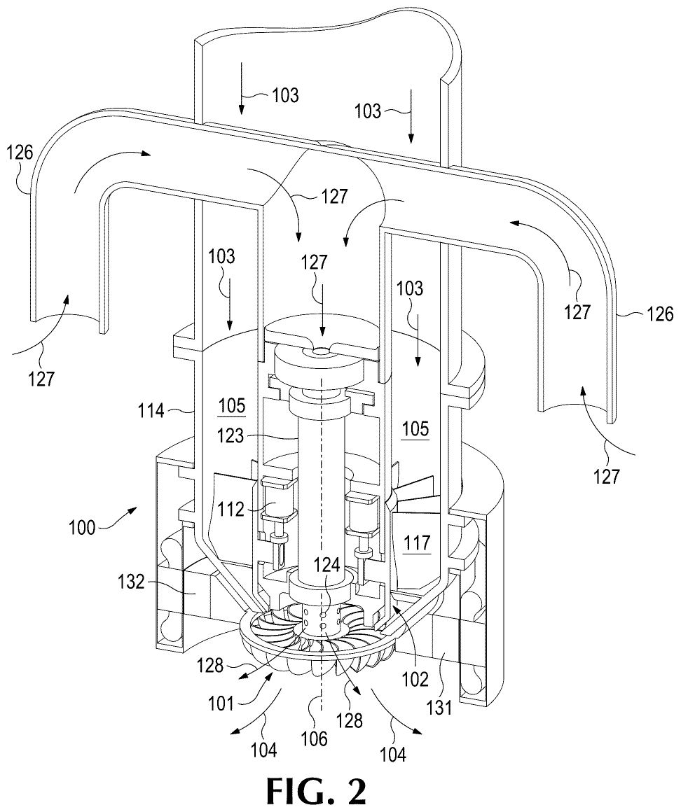

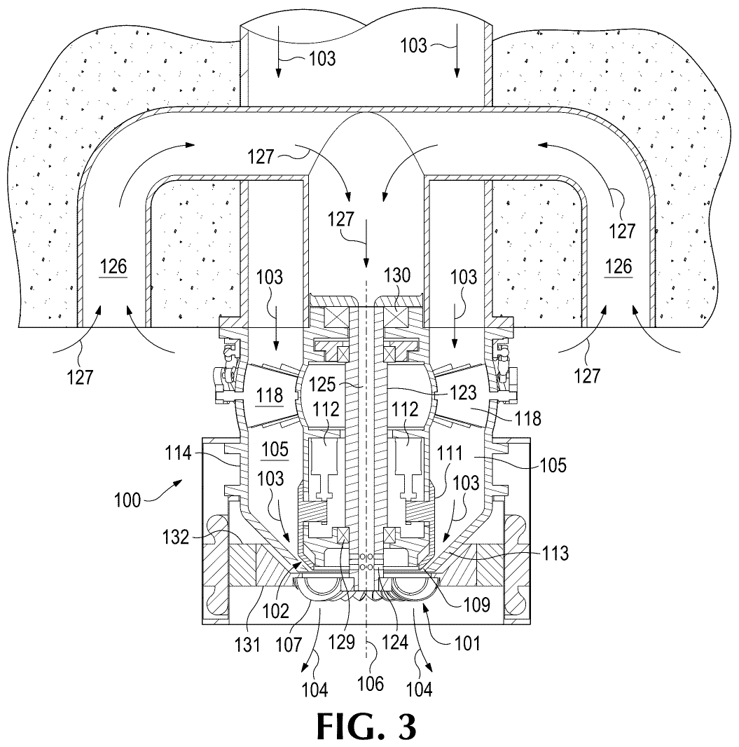

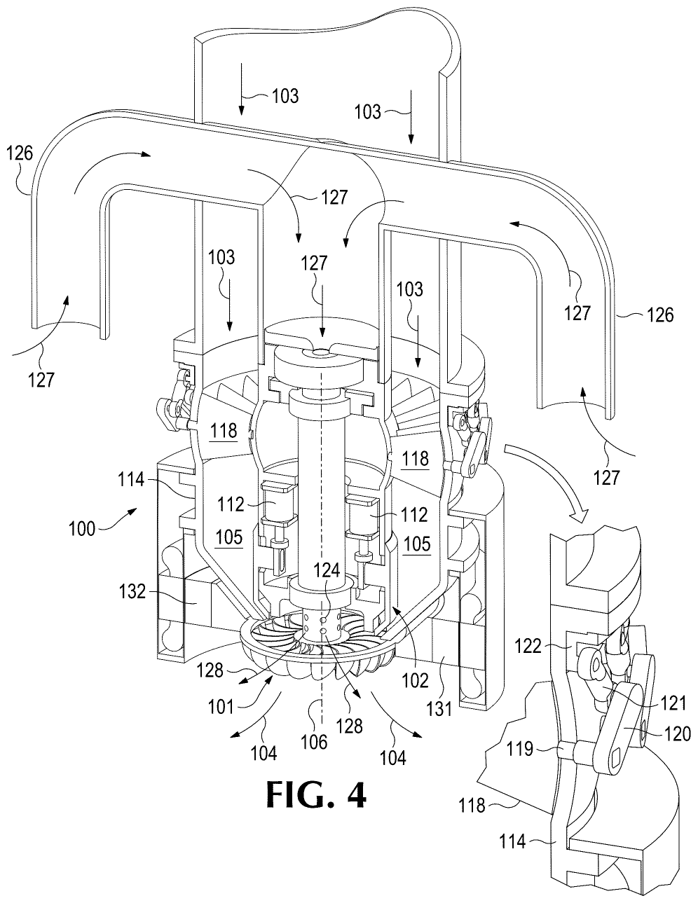

FIG. 1 is a sectional view illustrating aspects of a turbine 100 that is configured to produce a conical-sheet flow and that has fixed guide-vanes 117, according to an example configuration. FIG. 2 is an isometric, partial sectional view of the turbine 100 of FIG. 1. FIG. 3 is a sectional view illustrating aspects of a turbine 100 that is configured to produce a conical-sheet flow and that has adjustable wicket gates 118, according to an example configuration. FIG. 4 is an isometric, partial sectional view of the turbine 100 of FIG. 3. FIG. 4 also includes an additional detail view of a portion of the turbine 100 of FIG. 3 so that additional features can be labeled.

As illustrated in FIGS. 1-4, configurations of a turbine 100 include a runner 101 and a variable nozzle 102. The arrows 103 show the direction of fluid flow toward the runner 101, and the arrows 104 show the direction of fluid flow exiting the runner 101. The fluid is typically water. As illustrated, the variable nozzle 102 is upstream from the runner 101, and the fluid approaches the variable nozzle 102 through an annular passageway 105.

The runner 101 is an impulse runner that is configured to rotate about an axis of rotation 106. The runner 101 is similar to the impulse runner on a Pelton or a Turgo turbine. In the illustrated configuration, the runner 101 has runner buckets 107 that are configured to receive the kinetic energy of the fluid striking the runner buckets 107 and convert that to rotational motion of the runner 101. Interaction with the runner buckets 107, which are rotating at approximately half the sheet tangential velocity, results in the water of the sheet transferring most of its energy to the moving runner 101 and departing the runner 101 with just enough speed to flow clear of the runner 101.

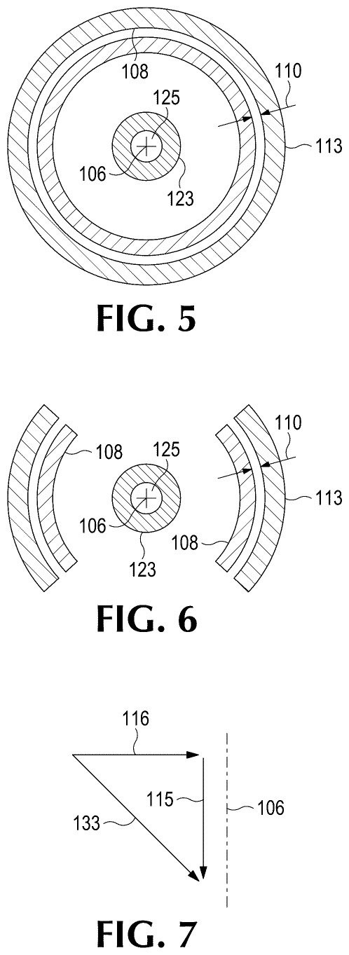

As explained here and shown in the drawings, the variable nozzle 102 is configured to produce a conical-sheet flow when fluid passes through the variable nozzle 102 toward the runner 101. In the illustrated configuration, the variable nozzle 102 is annular and substantially surrounds the axis of rotation 106. As used in this context, “substantially surrounds” means largely or essentially extending around, without requiring perfect encircling. In other configurations, the variable nozzle 102 partially surrounds the axis of rotation 106 without substantially surrounding the axis of rotation 106. (See the discussions of FIGS. 5 and 6 below.) In either case (substantially surrounding or partially surrounding), the variable nozzle 102 is axisymmetric.

The conical-sheet flow has a circumferential length 108 at an exit 109 of the variable nozzle 102. As illustrated, the circumferential length 108 is the length of the conical-sheet flow as measured circumferentially about the axis of rotation 106. For configurations where the variable nozzle 102 substantially surrounds the axis of rotation 106, the circumferential length 108 is the circumference of the circle of the variable nozzle 102, an example of which is shown in FIG. 5. FIG. 5 is an axial, end view of an example of conical-sheet flow exiting the nozzle of the turbine 100 of FIG. 1 or FIG. 3. For configurations where the variable nozzle 102 partially surrounds the axis of rotation 106, the circumferential length 108 is the arclength of the arc of the variable nozzle 102, examples of which are shown in FIG. 6. FIG. 6 is an axial, end view of an example conical-sheet flow exiting the nozzle of the turbine 100 of FIG. 1 or FIG. 3. The conical-sheet flow also has a radial flow width 110 (i.e. the width of the conical-sheet flow in the radial direction) at the exit 109 of the variable nozzle 102. The radial flow width 110 is perpendicular to the axis of rotation 106 and, therefore, also perpendicular to the circumferential length 108. Accordingly, the radial flow width 110 is the width of the annular (or partially annular), conical-sheet flow when measured radially, examples of which are shown in FIGS. 5-6. The objective of this paragraph is to distinguish the described technology, which uses a sheet flow, from previous technologies that use one or more circular jets to cause a runner to spin.

The radial flow width 110 is adjustable. For example, the radial flow width 110 is adjustable between a first radial flow width 110 and a second radial flow width 110, where the first radial flow width 110 is greater than the second radial flow width 110. In configurations, such as the configuration illustrated in FIGS. 1-4, the variable nozzle 102 includes a movable gate 111. The movable gate 111 is coupled to one or more actuators 112. Each actuator 112 is configured to axially move the movable gate 111 toward and away from a second gate 113 of the variable nozzle 102. Each actuator 112 may be, for example, a linear actuator, such as a hydraulic actuator or an electromechanical actuator. The second gate 113 of the nozzle is in a fixed position relative to the movable gate 111. As illustrated, in configurations the second gate 113 of the nozzle might be integrated with the outer wall 114 of the annular passageway 105. Accordingly, the movable gate 111 allows the radial flow width 110 to be adjustable between the first radial flow width 110 and the second radial flow width 110. The movable gate 111 is closer to the second gate 113 for the second radial flow width 110 than it is for the first radial flow width 110. The radial flow width 110 is the distance between the movable gate 111 and the second gate 113 at the exit 109 of the variable nozzle 102. The radial flow width 110 is continuously variable between the first radial flow width 110 and the second radial flow width 110 because the movable gate 111 is continuously variable relative to the second gate 113 as described above.

In the illustrated configuration, and with particular reference to FIG. 7, the conical-sheet flow has an axial flow component 115 and a radial flow component 116. The radial flow component 116 is directed toward the axis of rotation 106. Accordingly, the sheet flow produced by the variable nozzle 102 of FIGS. 1-4 is cone shaped, the cone converging as the sheet flow approaches the runner 101 from the exit 109 of the variable nozzle 102. In other configurations, the sheet flow could be cylindrical, having no radial component so that the flow is only in the axial direction. In other configurations, the cone shape could diverge as the sheet flow approaches the runner 101 from the exit 109 of the variable nozzle 102. Even so, divergent flows are typically not preferred as such sheets of water are unstable and break apart into droplets. By contrast, inwardly flowing (convergent) sheets of water are inherently stable as they converge toward the runner 101. In each case (converging cone, diverging cone, or cylindrical), the sheet flow is axisymmetric.

In configurations, such as the configuration illustrated in FIGS. 1-2, the turbine 100 further includes fixed guide-vanes 117 upstream of the exit 109 of the variable nozzle 102. The fixed guide-vanes 117 condition the incoming fluid flow at the entrance to the variable nozzle 102 by adjusting the whirl angle upstream of the adjustable nozzle.

In configurations, such as the configuration illustrated in FIGS. 3-4, the turbine 100 further includes radial, adjustable wicket gates 118 upstream of the exit 109 of the variable nozzle 102. The adjustable wicket gates 118 condition the incoming fluid flow at the entrance to the variable nozzle 102. If we assume constant speed operation, it is desirable that the sheet of water produced by the variable nozzle 102 engage the runner 101 at the same angle and pitch diameter at which a Pelton jet would engage the runner 101. This may be accomplished with the wicket gates by adjusting the whirl angle upstream of the adjustable nozzle. Coordination of the wicket gate angle with the sheet jet thickness results in a sheet jet of constant inlet angle. In the illustrated configuration, the angle of the adjustable wicket gate 118 angle is controlled via a wicket gate actuation system, including a wicket gate pin 119, a wicket gate lever 120, a wicket gate link 121, and wicket gate shifting ring 122.

As illustrated, the turbine 100 may include an axial shaft 123 that is coincident with the axis of rotation 106. The shaft 123 is coupled to the runner 101 at an end of the shaft 123. In configurations, such as the configuration illustrated in FIGS. 1-4, the end of the shaft 123 that is coupled to the runner 101 has one or more airholes 124. In such configurations, the shaft 123 further has an air passageway 125 extending from the end of the shaft 123 coupled to the runner 101 to an opposite end of the shaft 123. As illustrated, the airholes 124 may be positioned radially on the shaft 123. Accordingly, air may enter the air passageway 125 of the shaft 123 from airducts 126 and exit the air passageway 125 of the shaft 123 through the airholes 124. This provides air to the region near the runner 101. Specifically, where the variable nozzle 102 substantially surrounds the axis of rotation 106, the sheet flow provides no voids for air to pass through the flow toward the region between the sheet flow and the shaft 123. Air is required, however, to fill the low-pressure zones that develop in the vicinity of the runner 101 to prevent cavitation and to provide air to replace that lost by entrainment with the sheet flow. The arrows 127 show the direction of airflow through the airducts 126 and into the air passageway 125 of the shaft 123, and the arrows 128 show the direction of air exiting the airholes 124. In the illustrated configuration, radial bearings 129 and thrust bearings 130 support the shaft 123.

In configurations, such as the configuration illustrated in FIGS. 1-4, the turbine 100 further includes a rotor 131 and a stator 132. The rotor 131 is driven by the runner 101 and rotates about the axis of rotation 106 with the runner 101. The stator 132 is radially external to the rotor 131, and the rotor 131 rotates within the stator 132.

The turbine 100 illustrated in FIGS. 1-4 may be used, as one example, to replace a Howell Bunger (fixed cone) valve at an existing, non-powered dam.

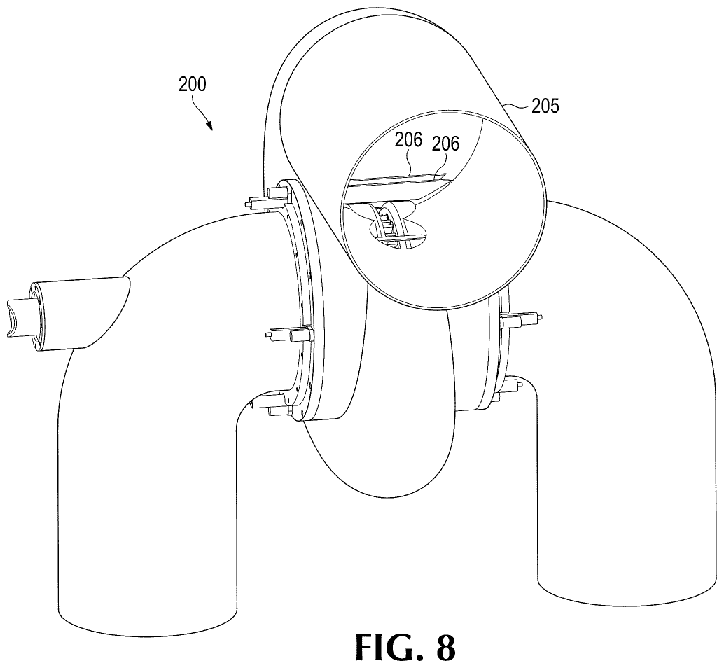

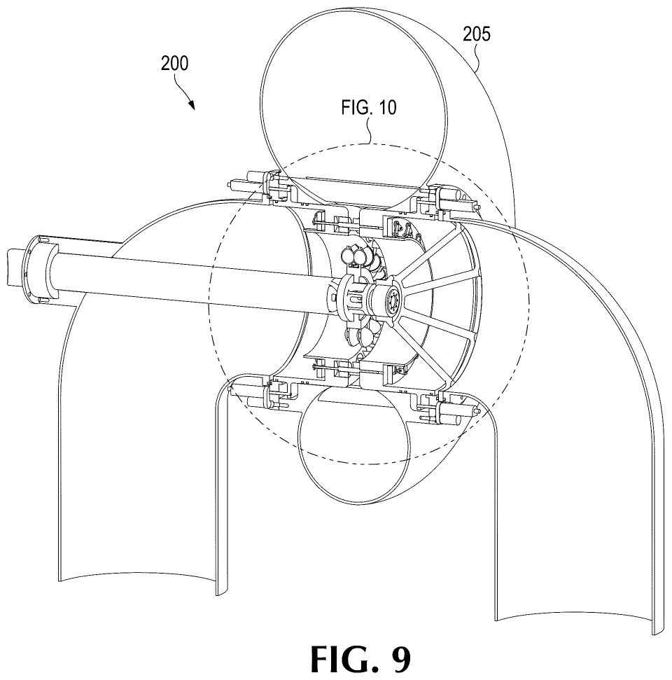

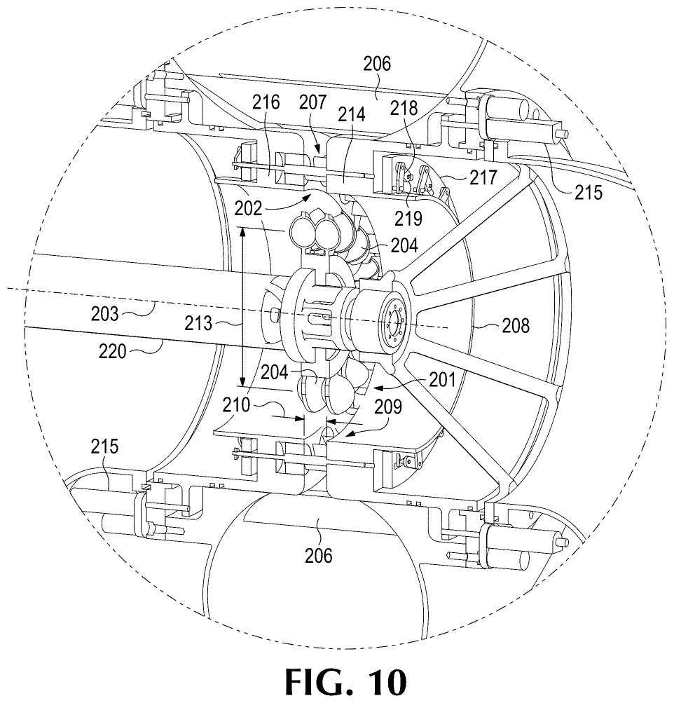

FIG. 8 is an isometric view of a turbine that is configured to produce a planar-sheet flow, according to an example configuration. FIG. 9 is a sectional view of the turbine of FIG. 8. FIG. 10 is a detail view of a portion of the turbine of FIG. 9. As illustrated in FIGS. 8-10, configurations of a turbine 200 include a runner 201 and a variable nozzle 202.

The runner 201 is an impulse runner 201 that is configured to rotate about an axis of rotation 203. The runner 201 is similar to the impulse runner 201 on a Pelton wheel. In the illustrated configuration, the runner 201 has runner buckets 204 that are configured to receive the kinetic energy of the fluid striking the runner buckets 204 and convert that to rotational motion of the runner 201. The fluid is typically water. As illustrated, a scroll case 205 may be reinforced with stay vanes 206 to distribute water to a set of wicket gates similar to those used in high-head Francis turbines. Fluid from the scroll case 205 enters the variable nozzle 202 after having passed through the adjustable wicket gates 207.

As explained here and shown in the drawings, the variable nozzle 202 is configured to produce a planar-sheet flow when fluid passes through the variable nozzle 202 toward the runner 201. The planar-sheet flow has a circumferential length 208 at an exit 209 of the variable nozzle 202. As illustrated, the circumferential length 208 is the length of the planar-sheet flow as measured circumferentially at the exit 209 of the variable nozzle 202 and about the axis of rotation 203. The planar-sheet flow has an axial flow width 210 at the exit 209 of the variable nozzle 202. The axial flow width 210 is parallel to the axis of rotation 203 and perpendicular to the circumferential length 208. The circumferential length 208 is greater than the axial flow width 210. The variable nozzle 202 is axisymmetric.

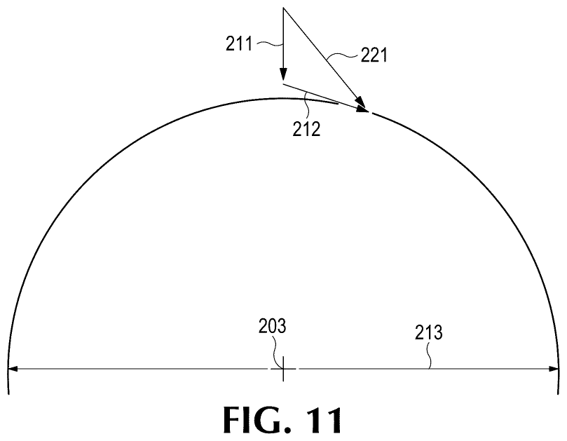

As best illustrated in FIG. 11, the planar-sheet flow has an radial flow component 211 and a tangential flow component 212. The tangential flow component 212 is tangential to the pitch diameter 213 of the runner 201.

Accordingly, the flow produced by the adjustable nozzle is a “sheet” in that it has an axial flow width 210 that is less than its circumferential length 208. This distinguishes the described technology from previous technologies that use one or more circular jets to cause a runner to spin. Also, the flow produced by the adjustable nozzle of FIGS. 8-10 is “planar” in that the flow pattern is relatively flat as compared to the conical flow pattern described above for FIGS. 1-7. The planar-sheet flow has no flow component in the axial direction.

The axial flow width 210 is adjustable between a first axial flow width 210 and a second axial flow width 210, where the first axial flow width 210 is greater than the second axial flow width 210. In configurations, such as the configuration illustrated in FIGS. 8-10, the variable nozzle 202 includes a movable gate 214. The movable gate 214 is coupled to one or more actuators 215. Each actuator 215 is configured to axially move the movable gate 214 toward and away from a second gate 216 of the nozzle. Each actuator 215 may be, for example, a linear actuator, such as a hydraulic actuator or an electromechanical actuator. The second gate 216 of the nozzle is in a fixed position relative to the movable gate 214. Accordingly, the movable gate 214 allows the axial flow width 210 to be adjustable between the first axial flow width 210 and the second axial flow width 210. The movable gate 214 is closer to the second gate 216 for the second axial flow width 210 than it is for the first axial flow width 210. The axial flow width 210 is the distance between the movable gate 214 and the second gate 216 at the exit 209 of the variable nozzle 202. The axial flow width 210 is continuously variable between the first axial flow width 210 and the second axial flow width 210 because the movable gate 214 is continuously variable relative to the second gate 216 as described above.

In configurations, such as the configuration illustrated in FIGS. 8-10, the turbine 200 further includes adjustable wicket gates 207 upstream of the exit 209 of the variable nozzle 202. The adjustable wicket gates 207 impart the radial flow component 211 and the tangential flow component 212 at the exit 209 of the variable nozzle 202. The angle of the adjustable wicket gates 207 is controlled through an actuation system where linear actuators 215 rotate a shifting ring 217 around the axis of the runner 201. One end of a wicket gate link 218 is connected to the shifting ring 217 while the other end of the wicket gate link 218 is connected to a wicket gate lever 219. When the shifting ring 217 rotates, each of the wicket gate links 218 drives a wicket gate lever 219 to rotate about the wicket gate axis, thus controlling the angle of the adjustable wicket gates 207.

Coordinated adjustment of the adjustable wicket gates 207 and the adjustable nozzle results in water being delivered tangentially to the pitch diameter 213 of the runner 201 over a range of sheet jet thicknesses and turbine 200 flow rates. Jet thickness and wicket gate angle may be coordinated to achieve maximum efficiency for a given rotational speed and currently available head.

As illustrated, the turbine 200 may include an axial shaft 220 that is coincident with the axis of rotation 203. In configurations, the turbine 200 is coupled to generator that includes a rotor that is driven by the runner 201. The generator may be, for example, coupled to the shaft 220, typically at an opposite end of the shaft 220 from where the runner 201 is located.

### EXAMPLES

Illustrative examples of the disclosed technologies are provided below. A particular configuration of the technologies may include one or more, and any combination of, the examples described below.

Example 1 includes a turbine comprising: a runner configured to rotate about an axis of rotation; and a variable nozzle configured to produce a sheet flow when fluid passes through the variable nozzle toward the runner, the sheet flow having a circumferential length at an exit of the variable nozzle that is greater than a flow width at the exit of the variable nozzle, the flow width being perpendicular to the circumferential length, the flow width being adjustable between a first flow width and a second flow width, where the first flow width is greater than the second flow width.

Example 2 includes the turbine of Example 1, the variable nozzle comprising a movable gate coupled to at least one actuator that is configured to move the movable gate toward and away from a second gate of the nozzle, the movable gate allowing the flow width to be adjustable between the first flow width and the second flow width.

Example 3 includes the turbine of Example 2, in which the movable gate is coupled to at least one actuator that is configured to axially move the movable gate toward and away from the second gate of the nozzle, allowing the radial flow width to be continuously variable between the first radial flow width and the second radial flow width.

Example 4 includes the turbine of any of Examples 1-3, further comprising adjustable wicket gates upstream of the exit of the variable nozzle, the adjustable wicket gates configured to condition fluid flow at an entrance to the variable nozzle.

Example 5 includes a turbine comprising: a runner configured to rotate about an axis of rotation; and a variable nozzle configured to produce a conical-sheet flow when fluid passes through the variable nozzle toward the runner, the conical-sheet flow having a circumferential length at an exit of the variable nozzle that is greater than a radial flow width at the exit of the variable nozzle, the radial flow width being perpendicular to the circumferential length, the radial flow width being adjustable between a first radial flow width and a second radial flow width, where the first radial flow width is greater than the second radial flow width, the conical-sheet flow having an axial flow component and a radial flow component, the radial flow component being directed toward the axis of rotation.

Example 6 includes the turbine of Example 5, further comprising: a rotor driven by the runner and configured to rotate about the axis of rotation; and a stator that is radially external to the rotor, the rotor configured to rotate within the stator.

Example 7 includes the turbine of any of Examples 5-6, the variable nozzle comprising a movable gate coupled to at least one actuator that is configured to axially move the movable gate toward and away from a second gate of the nozzle, allowing the radial flow width to be continuously variable between the first radial flow width and the second radial flow width.

Example 8 includes the turbine of any of Examples 5-7, further comprising fixed guide-vanes upstream of the exit of the variable nozzle, the fixed guide-vanes configured to condition fluid flow at an entrance to the variable nozzle.

Example 9 includes the turbine of any of Examples 5-7, further comprising adjustable wicket gates upstream of the exit of the variable nozzle, the adjustable wicket gates configured to condition fluid flow at an entrance to the variable nozzle.

Example 10 includes the turbine of any of Examples 5-9, further comprising an axial shaft coincident with the axis of rotation, the shaft being coupled to the runner at an end of the shaft, the end of the shaft having one or more airholes, the shaft further having an air passageway extending from the end of the shaft to an opposition end of the shaft.

Example 11 includes turbine comprising: a runner configured to rotate about an axis of rotation; and a variable nozzle configured to produce a planar-sheet flow when fluid passes through the variable nozzle toward the runner, the planar-sheet flow having a circumferential length at an exit of the variable nozzle that is greater than an axial flow width at the exit of the variable nozzle, the axial flow width being perpendicular to the circumferential length, the axial flow width being adjustable between a first axial flow width and a second axial flow width, where the first axial flow width is greater than the second axial flow width, the planar-sheet flow having an radial flow component and a tangential flow component.

Example 12 includes the turbine of Example 11, the variable nozzle comprising a movable gate coupled to at least one actuator that is configured to axially move the movable gate toward and away from a second gate of the nozzle, allowing the axial flow width to be continuously variable between the first axial flow width and the second axial flow width.

Example 13 includes the turbine of any of Examples 11-12, further comprising adjustable wicket gates upstream of the exit of the variable nozzle, the adjustable wicket gates configured to impart the radial flow component and the tangential flow component at the exit of the variable nozzle.

The contents of the present document have been presented for purposes of illustration and description, but such contents are not intended to be exhaustive or limited to the disclosure in the form disclosed. Many modifications and variations will be apparent to those of ordinary skill in the art without departing from the scope and spirit of the disclosure. The aspects of the disclosure in this document were chosen and described to explain the principles of the disclosure and the practical application, and to enable others of ordinary skill in the art to understand the disclosure with various modifications as are suited to the particular use contemplated.

Accordingly, it is to be understood that the disclosure in this specification includes all possible combinations of the particular features referred to in this specification. For example, where a particular feature is disclosed in the context of a particular example configuration, that feature can also be used, to the extent possible, in the context of other example configurations.

Additionally, the described versions of the disclosed subject matter have many advantages that were either described or would be apparent to a person of ordinary skill. Even so, all of these advantages or features are not required in all versions of the disclosed apparatus, systems, or methods.

Also, when reference is made in this application to a method having two or more defined steps or operations, the defined steps or operations can be carried out in any order or simultaneously, unless the context excludes those possibilities.

The terminology used in this specification is for the purpose of describing particular aspects only and is not intended to be limiting of the disclosure. As used herein, the singular forms “a,” “an,” and “the” are intended to include the plural forms as well, unless the context clearly indicates otherwise. It will be further understood that the terms “comprises” or “comprising,” when used in this specification, specify the presence of stated features, integers, steps, operations, elements, or components, but do not preclude the presence or addition of one or more other features, integers, steps, operations, elements, components, or groups thereof. Hence, for example, an article “comprising” or “which comprises” components A, B, and C can contain only components A, B, and C, or it can contain components A, B, and C along with one or more other components.

It is understood that the present subject matter may be embodied in many different forms and should not be construed as being limited to the example configurations set forth in this specification. Rather, these example configurations are provided so that this subject matter will be thorough and complete and will convey the disclosure to those skilled in the art. Indeed, the subject matter is intended to cover alternatives, modifications, and equivalents of these example configurations, which are included within the scope and spirit of the subject matter set forth in this disclosure. Furthermore, in the detailed description of the present subject matter, specific details are set forth to provide a thorough understanding of the present subject matter. It will be clear to those of ordinary skill in the art, however, that the present subject matter may be practiced without such specific details.

I/We claim:

1. A turbine comprising:
a runner configured to rotate about an axis of rotation; and
a variable nozzle configured to produce a sheet flow when fluid passes through the variable nozzle toward the runner, the sheet flow having a circumferential length at an exit of the variable nozzle that is greater than a flow width at the exit of the variable nozzle, the flow width being perpendicular to the circumferential length, the flow width being adjustable between a first flow width and a second flow width, where the first flow width is greater than the second flow width.

2. The turbine of claim 1, the variable nozzle comprising a movable gate coupled to at least one actuator that is configured to move the movable gate toward and away from a second gate of the nozzle, the movable gate allowing the flow width to be adjustable between the first flow width and the second flow width.

3. The turbine of claim 2, in which the movable gate is coupled to at least one actuator that is configured to axially move the movable gate toward and away from the second gate of the nozzle, allowing the radial flow width to be continuously variable between the first radial flow width and the second radial flow width.

4. The turbine of claim 1, further comprising adjustable wicket gates upstream of the exit of the variable nozzle, the adjustable wicket gates configured to condition fluid flow at an entrance to the variable nozzle.

5. A turbine comprising:
a runner configured to rotate about an axis of rotation; and
a variable nozzle configured to produce a conical-sheet flow when fluid passes through the variable nozzle toward the runner, the conical-sheet flow having a circumferential length at an exit of the variable nozzle that is greater than a radial flow width at the exit of the variable nozzle, the radial flow width being perpendicular to the circumferential length, the radial flow width being adjustable between a first radial flow width and a second radial flow width, where the first radial flow width is greater than the second radial flow width, the conical-sheet flow having an axial flow component and a radial flow component, the radial flow component being directed toward the axis of rotation.

6. The turbine of claim 5, further comprising:
a rotor driven by the runner and configured to rotate about the axis of rotation; and
a stator that is radially external to the rotor, the rotor configured to rotate within the stator.

7. The turbine of claim 5, the variable nozzle comprising a movable gate coupled to at least one actuator that is configured to axially move the movable gate toward and away from a second gate of the nozzle, allowing the radial flow width to be continuously variable between the first radial flow width and the second radial flow width.

8. The turbine of claim 5, further comprising fixed guide-vanes upstream of the exit of the variable nozzle, the fixed guide-vanes configured to condition fluid flow at an entrance to the variable nozzle.

9. The turbine of claim 5, further comprising adjustable wicket gates upstream of the exit of the variable nozzle, the adjustable wicket gates configured to condition fluid flow at an entrance to the variable nozzle.

10. The turbine of claim 5, further comprising an axial shaft coincident with the axis of rotation, the shaft being coupled to the runner at an end of the shaft, the end of the shaft having one or more airholes, the shaft further having an air passageway extending from the end of the shaft to an opposition end of the shaft.

11. A turbine comprising:
a runner configured to rotate about an axis of rotation; and
a variable nozzle configured to produce a planar-sheet flow when fluid passes through the variable nozzle toward the runner, the planar-sheet flow having a circumferential length at an exit of the variable nozzle that is greater than an axial flow width at the exit of the variable nozzle, the axial flow width being perpendicular to the circumferential length, the axial flow width being adjustable between a first axial flow width and a second axial flow width, where the first axial flow width is greater than the second axial flow width, the planar-sheet flow having an radial flow component and a tangential flow component.

12. The turbine of claim 11, the variable nozzle comprising a movable gate coupled to at least one actuator that is configured to axially move the movable gate toward and away from a second gate of the nozzle, allowing the axial flow width to be continuously variable between the first axial flow width and the second axial flow width.

13. The turbine of claim 11, further comprising adjustable wicket gates upstream of the exit of the variable nozzle, the adjustable wicket gates configured to impart the radial flow component and the tangential flow component at the exit of the variable nozzle.
